(19) United States
(12) Patent Application Publication
(10) Pub. No.: US 2002/0131628 A1
(43) Pub. Date: Sep. 19, 2002

(54) Medical image generating apparatus, medical image processing apparatus and medical network system

(75) Inventor: Haruyuki Toda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/094,721

(22) Filed: Mar. 11, 2002

(30) Foreign Application Priority Data
Mar. 15, 2001 (JP) 073780/2001

(51) Int. Cl. G06K 9/00

(52) U.S. Cl. 382/132

(57) ABSTRACT

A medical image generating apparatus for generating medical image data and for transmitting them to another apparatus, in which there are provided a means to make reduction images for image processing for determining image processing conditions from the image data and a means to transmit the reduction images for image processing as a part of collateral information of an image file including the image data.

### BACKGROUND OF THE INVENTION

The present invention relates to a medical image generating apparatus, a medical image processing apparatus and to a medical network system.

Radiographic images are commonly used for diagnoses of sickness, and a known method for obtaining the radiographic image is one wherein radiations which are emitted from a radiation emitting section and are transmitted through a subject are absorbed in a plate-shaped stimulable phosphor, then, the stimulable phosphor is scanned by a laser beam to be excited, thereby, radiation energy (radiographic image information) accumulated in the stimulable phosphor through the aforesaid absorption is made to radiate as fluorescence, and the fluorescence is subjected to photoelectric transfer to obtain radiographic image signals and thereby to read the radiographic image.

In a conventional system, an image file is transmitted from a medical image generating apparatus that reads and generates a medical image as stated above and is received, then, reduction images are made from image data in the image file, then, an image processing parameter is determined and image processing is conducted, and the reduction images are displayed as reference for confirmation of radiographic images or they are displayed on a thumbnail basis.

However, in the conventional system wherein image processing and image display cannot be started until an end of receiving of an image file, it has taken a long time from an end of receiving of the image file up to image processing and making reduction images, and it has been impossible to display the reduction images rapidly, which has been inconvenient. In addition, there is required a memory to develop image data for displaying reduction images, which causes an increase of cost of the system.

### SUMMARY OF THE INVENTION

An object of the invention is to provide a medical image generating apparatus, a medical image processing apparatus and a medical network system, wherein it is possible to display reduction images for display and to confirm medical images on the receiving side without waiting an end of receiving of an image file of radiographic images, and an a memory to develop image data on the receiving side is not needed.

For achieving the object stated above, the medical image generating apparatus of the invention is one for generating medical image data and for transmitting them to another apparatus, wherein there are provided a means to make reduction images for image processing for determining image processing conditions from the image data and a means to transmit the reduction images for image processing as a part of collateral information of an image file including the image data.

In the medical image generating apparatus, a memory for developing image data at the receiving side is not needed and a period of time for developing image data is not needed, because image processing conditions can be determined from reduction images for image processing transmitted as a part of collateral information of an image file.

Another medical image generating apparatus of the invention is one for generating medical image data and for transmitting them to another apparatus, wherein there are provided a means to make reduction images for image processing for determining image processing conditions from the image data and a means to transmit the reduction images for image processing as a separate file before transmission of an image file including the image data.

In the medical image generating apparatus, a memory for developing image data at the receiving side is not needed and a period of time for developing image data is not needed, because image processing conditions can be determined from reduction images for image processing transmitted as a separate file. Further, since the reduction images for image processing are transmitted as a file that is separate from the image file, it is possible to conduct image processing for reduction images for display on the receiving side before receiving the image file entirely. This makes it possible to display reduction images for display and to confirm medical images at the receiving side, without waiting an end of receiving of the image file.

The still another medical image generating apparatus of the invention is one for generating medical image data and for transmitting them to another apparatus, wherein there are provided a means to make, from the image data, reduction images for web site to be used in the web site and a means to transmit the reduction images for web site as a part of collateral information of an image file including the image data.

In the medical image generating apparatus, a memory for developing image data at the receiving side is not needed and a period of time for developing image data is not needed, because reduction images for web site are transmitted as a part of collateral information of an image file.

The still another medical image generating apparatus of the invention is one for generating medical image data and for transmitting them to another apparatus, wherein there are provided a means to make reduction images for image processing for determining image processing conditions from the image data, a means to make reduction images for display from the image data and a means to transmit the respective reduction image as a part of collateral information of an image file including the image data.

In the medical image generating apparatus, a memory for developing image data on the receiving side is not needed and a period of time for developing image data is not needed, because reduction images for image processing and reduction images for display are transmitted as a part of collateral information of an image file.

The still another medical image generating apparatus of the invention is one for generating medical image data and for transmitting them to another apparatus, wherein there are provided a means to make reduction images for image processing for determining image processing conditions from the image data, a means to make, from the image data, the reduction images for web site to be used in the web site and a means to transmit the respective reduction image as a part of collateral information of an image file including the image data.

In the medical image generating apparatus, a memory for developing image data on the receiving side is not needed and a period of time for developing image data is not needed, because reduction images for image processing and reduction images for web site are transmitted as a part of collateral information of an image file.

The still another medical image generating apparatus of the invention is one for generating medical image data and for transmitting them to another apparatus, wherein there are provided a means to make reduction images for display from the image data, and a means to transmit the reduction images for display as a separate file before transmitting an image file including the image data.

In the medical image generating apparatus, a memory for developing image data on the receiving side is not needed and a period of time for developing image data is not needed, because reduction images for display are transmitted under the separate file. Further, since the reduction images for display are transmitted as a file that is separate from the image file, it is possible to conduct image processing for reduction images for display on the receiving side before receiving the image file entirely. This makes it possible to display reduction images for display and to confirm medical images on the receiving side, without waiting an end of receiving of the image file.

The still another medical image generating apparatus of the invention is one for generating medical image data and for transmitting them to another apparatus, wherein there are provided a means to make reduction images for web site to be used in the web site from the image data, and a means to transmit the reduction images for web site as a separate file before transmitting an image file including the image data.

In the medical image generating apparatus, a memory for developing image data on the receiving side is not needed and a period of time for developing image data is not needed because reduction images for web site are transmitted under the separate file. Further, since the reduction images for web site are transmitted as a file that is separate from the image file, it is possible to conduct image processing for reduction images for web site on the receiving side before receiving the image file entirely.

The still another medical image generating apparatus of the invention is one for generating medical image data and for transmitting them to another apparatus, wherein there are provided a means to make reduction images for image processing for determining image processing conditions from the image data, a means to make, from the image data, the reduction images for display based on the image processing conditions and a means to transmit the respective reduction image as a separate file before transmitting an image file including the image data.

In the medical image generating apparatus, a memory for developing image data on the receiving side is not needed and a period of time for developing image data is not needed, because reduction images for image processing and reduction images for display are transmitted under the separate file. Further, since reduction images for image processing and reduction images for display are transmitted as a file that is separate from an image file, it is possible to conduct image processing for reduction images for display on the receiving side before receiving the image file entirely. This makes it possible to display reduction images for display and to confirm medical images on the receiving side, without waiting an end of receiving of the image file.

The still another medical image generating apparatus of the invention is one for generating medical image data and for transmitting them to another apparatus, wherein there are provided a means to make reduction images for image processing for determining image processing conditions from the image data, a means to make, from the image data, the reduction images for web site to be used in the web site based on the image processing conditions and a means to transmit the respective reduction image as a separate file before transmitting an image file including the image data.

In the medical image generating apparatus, a memory for developing image data on the receiving side is not needed and a period of time for developing image data is not needed, because reduction images for image processing and reduction images for web site are transmitted under the separate file. Further, since reduction images for image processing and reduction images for web site are transmitted as a file that is separate from an image file, it is possible to conduct image processing for reduction images for display on the receiving side before receiving the image file entirely.

It is preferable that there is provided a means to transmit the image file before an operator of the image file instructs the transmission. Due to this, it is possible to shorten a period of time required by image confirmation and operation by the operator.

It is preferable that there is provided a means to instruct deletion of the transmitted image file to the target for transmission when discontinuation of transmission of the image file is instructed. Further, it is preferable that there is provided a means to transmit only the changed collateral information when the collateral information of the image file is changed after transmission of the image file.

It is preferable to provide a means to transmit the respective reduction image before transmission of the image file, and thereby, it is possible to shorten a period of time required by image confirmation and operations conducted by an operator.

It is preferable that there is provided a means to instruct deletion of the respective each reduction image transmitted image to the target for transmission when discontinuation of transmission of the image file is instructed.

The medical image processing apparatus of the invention is characterized to have therein a means to receive the image file and the reduction image for image processing transmitted from the medical image generating apparatus stated above, a means to determine image processing conditions by using the reduction image for image processing, and a means to display a reduction image for display which has been subjected to image processing based on the image processing conditions determined.

The medical image processing apparatus can make a memory to be unnecessary and can contribute to cost reduction of the medical image processing apparatus, because receiving of the reduction image for image processing from an image generating apparatus as a part of collateral information or as a separate file makes it unnecessary to develop image data on the memory and to make a reduction image. Further, a period of time required for development of image data is made to be unnecessary. It is possible to determine image processing conditions by using the reduction image for image processing, and to display a reduction image for display which has been subjected to image processing under the determined image processing conditions.

Another medical image processing apparatus of the invention is characterized to have therein a means to receive the image file and the reduction image for display transmitted from the medical image generating apparatus stated above, and a means to display the reduction image for display which has been subjected to image processing based on the determined image processing conditions.

The medical image processing apparatus can make a memory to be unnecessary and can contribute to cost reduction of the medical image processing apparatus, because receiving of the reduction image for display from an image generating apparatus as a part of collateral information or as a separate file makes it unnecessary to develop image data on the memory and to make a reduction image. Further, a period of time required for development of image data is made to be unnecessary. It is possible to display a reduction image for display which has been subjected to image processing under the determined image processing conditions.

The medical network system of the invention is provided with the medical image generating apparatus stated above and a medical image processing apparatus, and the medical image processing apparatus is equipped with a means that receives the image file and the reduction image for image processing both transmitted from the medical image generating apparatus through the network, a means to determine image processing conditions by using the reduction image for image processing and a means to display the reduction image for display which has been subjected to image processing based on the determined image processing conditions.

The medical network system can make a memory to be unnecessary and can contribute to cost reduction of the whole system, because it is not necessary to develop image data on a memory and to make a reduction image when an image processing apparatus receives from an image generating apparatus a reduction image for image processing as a part of collateral information or as a separate file. Further, a period of time required for development of image data is made to be unnecessary. It is possible to determine image processing conditions by using the reduction image for image processing and to display a reduction image for display which has been subjected to image processing under the determined image processing conditions. Further, when transmitting from the image generating apparatus with a file that is separate from an image file, it is possible to conduct image processing for the reduction image for display before the image processing apparatus receives all image files. It is therefore possible to display the reduction image for display on the image processing apparatus and to conduct confirmation of medical images.

The medical network system of the invention is provided with the medical image generating apparatus stated above and a medical image processing apparatus, and the medical image processing apparatus is equipped with a means that receives the image file and the reduction image for display both transmitted from the medical image generating apparatus through the network and a means to display the reduction image for display which has been subjected to image processing based on the determined image processing conditions.

The medical network system can make a memory to be unnecessary and can contribute to cost reduction of the whole system, because it is not necessary to develop image data on a memory and to make a reduction image when an image processing apparatus receives from an image generating apparatus a reduction image for display as a part of collateral information or as a separate file. Further, a period of time required for development of image data is made to be unnecessary. It is possible to display a reduction image for display which has been subjected to image processing under the determined image processing conditions. Further, when transmitting from the image generating apparatus with a file that is separate from an image file, it is possible to conduct image processing for the reduction image for display before the image processing apparatus receives all image files. It is therefore possible to display the reduction image for display on the image processing apparatus and to conduct confirmation of medical images.

It is preferable that the medical image generating apparatus is provided with a means to transmit the image file to the medical image processing apparatus before an operator instructs the transmission of the image file. Further, it is preferable that the medical image generating apparatus is equipped with a means to instruct deletion of the transmitted image file to the medical image processing apparatus when discontinuation of transmission of the image file is instructed.

It is preferable that the medical image generating apparatus is equipped with a means that transmits only changed collateral information when the collateral information of the image file is changed after transmission of the image file.

It is preferable that the medical image generating apparatus is equipped with a means to transmit the respective reduction image to the medical image processing apparatus before transmission of the image file.

It is preferable that the medical image generating apparatus is equipped with a means to instruct deletion of the transmitted respective reduction image to the medical image processing apparatus when discontinuation of transmission of the image file is instructed.

### BRIEF DESCRIPTION OF THE DRAWINGS

FIG. 1 is a diagram showing the structure of a medical network system in the embodiment of the invention.

FIG. 2 is a block diagram showing the structure of medical image generating apparatus 1 shown in FIG. 1.

FIG. 3 is a block diagram showing the structure of medical image generating apparatus 2 shown in FIG. 1.

FIG. 4 is a block diagram of a controller of medical image generating apparatus 1 shown in FIG. 2.

FIG. 5 is a flow chart showing the order of each operation in the medical network system in FIG. 1.

### DETAILED DESCRIPTION OF THE INVENTION

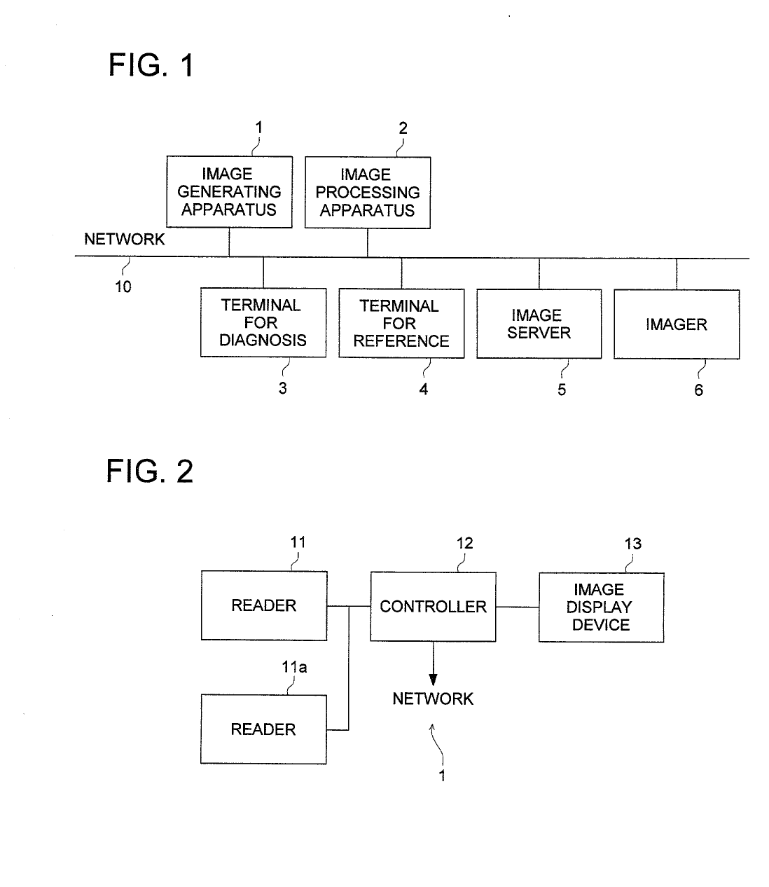

The medical network system in the embodiment of the invention will be explained as follows, referring to the drawings. FIG. 1 is a diagram showing the structure of a medical network system in the embodiment of the invention.

The medical network system shown in FIG. 1 is provided with medical image generating apparatus 1 wherein a medical image is generated by a radiographing modality of CR (computed radiography) that scans a stimulable phosphor panel in which radiographic image information of a subject (patient) is recorded to make it to emit light and transfers the light photoelectrically to obtain image information, medical image processing apparatus 2 that inputs an image file from the medical image generating apparatus 1 and outputs image information after conducting image processing, and with terminal for diagnosis 3 that is composed of a personal computer and a work station, and is used by a radiologist to diagnose by referring to images.

The medical network system shown in FIG. 1 is further provided with terminal for reference 4 that is composed of a personal computer and a workstation displaying images, and is inferior in quality such as resolution compared with the terminal for diagnosis 3 because no diagnosis is made although images are referred to, image server 5 that is composed of a personal computer and a workstation, and can store an image file in image data base and can detect images from the terminal for diagnosis 3 and from the terminal for reference 4 to read them, and imager (printer) 6 that outputs image data from medical image generating apparatus 1 and medical image processing apparatus 2 on a recording medium such as a film or paper. Each of the items 1-6 stated above is connected on an on-line connection basis through the network 10, so that information may be transmitted and received mutually.

Next, the following items A-I relating to medical image generating apparatus 1 in FIG. 1 will be explained in detail successfully.

A. Apparatus structure

B. Information

C. File

D. Input and display of main information

E. Reserving procedures

F. Radiographing procedures

G. Transfer

H. Output image forming

I. Utility function

A. Apparatus Structure

FIG. 2 is a block diagram showing the structure of medical image generating apparatus 1, and FIG. 4 is a block diagram showing the structure of a controller shown in FIG. 2.

a. As shown in FIG. 2, the medical image generating apparatus 1 is provided with radiographic image inputting apparatus (reader) 11 that converts information read from a stimulable phosphor panel on which radiographic image information of an object (patient) is accumulated and recorded to obtain, controller 12 that controls operations of the whole radiographing system for radiographic images, and image display device 13 that is composed of a CRT display or of a liquid crystal panel and displays digital image data obtained by the reader 11. Incidentally, the medical image generating apparatus 1 may also be provided with reader 11a, and it can include a plurality of readers. It further includes information inputting devices such as an input key board and a mouse.

b. The controller 12 constitutes a man-machine interface which is operated by a user (radiologist), and controls the whole of the medical image generating apparatus 1. As shown in FIG. 4, the controller 12 includes reading control section 36 that receives image data from readers 11 and 11a and conducts correction processing on a real time basis, preserving section 31 that is composed of a hard disc or RAM and stores and preserves various types of information such as image files from the reading control section 36, image processing section 32 that conducts image processing for image information in the image files, output image forming section 33 that forms output images to be outputted to the outside, image confirming/processing section 35 that conducts image processing for image confirmation and makes display device 13 to display reduction images, and main control apparatus 34 that controls operations of the whole apparatus including various sections 31-33 and 35 and the display device.

c. The controller 12 conducts the following operations (1) -(7) to be concrete.

1) A user operates for an appointment of radiographing.

2) A user operates for radiographing.

3) To receive image data obtained through reading by readers 11 and 11a.

4) To preserve image data in preserving section 31 temporarily.

5) To conduct image processing at image processing section 32.

6) To form output images at output image forming section 33.

7) To transmit to an outer apparatus such as image server 5 through the network 10.

B. Information

Information handled by the medical image generating apparatus 1 can be classified into the following five types of information.

a. Radiographing Information

Information with which radiographing is conducted to obtain image data which are outputted to an outer apparatus such as image server 5 as an image file.

The radiographing information includes the following information.

(a) Reader Reading Condition

Information concerning a method for reading by readers 11 and 11a, namely, an area to be read, a pixel size for reading and sensitivity for reading.

(b) X-ray Apparatus Information

Control information in the case of an occasion where a radiographing apparatus is connected to the network 10 on an on-line basis and is controlled from the system shown in FIG. 1, namely, X-ray tube voltage, X-ray tube current, X-ray radiation time and an area for radiation.

(c) Image Processing Information

Information relating to gradation processing and frequency processing in image processing of image data at image processing section 32.

(d) Outputting Apparatus Information

It is information relating to outer outputting apparatuses such as terminal for diagnosis 3, terminal for reference 4, image server 5 and imager 6 in FIG. 1 which reproduce image data for outputting them, and various pieces of information such as an area to be outputted, magnification and rate of reduction, output format (multi-format, split radiographing format), overlay and existence of gradation processing and frequency processing are designated for each outputting apparatus.

(e) Overlay Information

Information about existence and position of overlay such as AP/PA, R/L and comment.

(f) Information About Specific Designation

Information of protection: Image file is preserved in preserving section 31 until a protection is removed, even after image transmission.

Information of pending: Transmission is reserved. This is designated when transmission is needed after the image is reviewed.

Information of priority (emergency): This is designated when preferential transmission such as emergency radiographing is required. This is registered to be at the forefront of a cue.

b. Patient Information

Information concerning patients including the following information.

(a) Patient ID Information

An ID number, a full name, the distinction of sex and the date of birth of a patient.

(b) Order Information

Information with which a doctor requests radiographing, which includes information relating to patient conditions and instructions for the date and method for the inspection requested.

c. Information of Radiographing Implementation

Information concerning the results of radiographing which includes the following information.

(a) Results of Radiographing

Date and number for radiographing.

(b) Results of Image Processing

This is a result of calculation of image processing parameter, and image data are processed at image processing section 32 based on this result when outputting.

(c) System Information

This includes a part of system information such as a system structure at the point of time when radiographing is conducted.

d. System Information

This is information for controlling the whole system in FIG. 1, and it includes established information relating to outputting apparatuses such as system structures (outer apparatus such as image server 5 connected and it name), parameter to control equipment constituting the system, a table, reader information, imager information and HOST information.

e. Image Data

The following image data are included.

(a) Image data inputted from readers 11 and 11a.

(b) Reduction image data for display for making image display device 13 to display for image confirmation.

(c) Reduction image data for image processing for image processing of reduction image for display at image confirming/processing section 35.

(d) Output image data such as gradation processing and frequency processing.

C. File

A file handled by medical image generating apparatus 1 is preserved in preserving section 31, and it is classified into the following seven files.

a. Condition File

A radiographing condition key is a key for setting in advance radiographing conditions, image processing conditions and outing conditions, and it has a condition file that corresponds to each radiographing condition key. The condition file is composed of the radiographing information above mentioned. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Controller 12 establishes a condition file group for each of classified plural classifications, then, sets plural condition files for each condition file group thus established, and preserves in preserving section 31. The optimum condition is selected in the course of generating images.

b. Reservation File

This is a file in which information relating to radiographing reservation is preserved. One reservation file is prepared for each radiographing. The reservation file is composed of radiographing information selected by a radiographing condition key and of patient information.

c. Image Header File

After completion of radiographing, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

d. Reduction Image File

This represents image data which are obtained by reducing image data by image confirming/processing section 35 at a certain reduction ratio for image confirmation, and it includes the following. Incidentally, a method of image reduction includes a simple thinning out method, an averaging method and a spline method.

(a) Reduction Image data for Display

This reduction image for display is used by image data displayed on image display section 13 in FIG. 2 and FIG. 4.

(b) Reduction Image Data for Image Processing

This represents reduction image data for calculating a parameter with which the image confirming/processing section 35 conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

e. Image Data File

Corrected image data received from readers 11 and 11a in FIG. 2 are preserved in preserving section 31.

f. Output Image Data File

This is a file of output image data which have been subjected to the designated processing among frequency processing, gradation processing, overlay, rotation and enlargement and reduction.

g. System File

This is one wherein the system information mentioned above is filed.

D. Inputting and Display of Main Information

a. Reading Area

1) The reading area is an area where radiographic images accumulated in a stimulable phosphor are converted into image data. An appropriate area is designated in accordance with a region to be radiographed.

2) A size for reading, a direction and a position are designated, and registered in a condition file in advance.

3) When a condition file is selected, the reading area is displayed on a screen of image display device 13 in FIG. 2 under the condition designated in advance. A size of a display area of the reading area on the screen of the image display device 13 is made to be the maximum reading area in reading (normally, a 345×430 mm size). The reading area is determined from the designated reading size, the direction and the position, and is displayed graphically on the reading area display area. Due to this, appropriate reading size, direction and position can be selected and confirmed.

4) An irradiated area is received from an X-ray apparatus, and is displayed simultaneously on the reading area display area.

b. Output Area

1) The output area is an area for outputting to an outer apparatus such as image server 5.

2) An outputting size, a direction, a trimming position, an outputting position and a method of enlargement and reduction are designated, and registered in a condition file in advance.

3) When a radiographing condition key is selected, the output area and output image area are determined under the condition designated in advance, and are displayed on the screen of the image display device 13. A size of the output area display area on the screen of the image display device 13 is made to be the maximum output area in outputting. An output area and an output image area are displayed graphically on the output area display area. Due to this, the appropriate output area and the output image area can be selected and confirmed.

c. Overlay Information

1) It is designated whether or not “AP”, “PA”, “R”, “L”, comment and a division are overlaid, or where they are overlaid, and they are registered in a condition file in advance.

2) Output images are displayed on an output area display area on the screen of the image display device 13, and overlay information is displayed graphically there.

3) If a portion on the output area display area which needs to be overlaid is touched, overlay graphics are moved to that portion.

4) It is possible to select an appropriate overlay and to designate a position.

5) It is possible to confirm that a portion screened by the overlay to be invisible is not present. When the overlay causes troubles on diagnoses, it can be moved.

d. Inputting and Outputting of On-line Information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Reservation List

1) Reservations for radiographing can be displayed on the screen of the image display device 13 as a list in the order of reservations.

2) After completion of radiographing, the reservation for radiographing registered to be in the forefront of the reservation list is automatically set by controller 12 to be ready for radiographing.

3) The reservation for which radiographing has been finished is not erased, and is preserved until the number of the finished reservations arrives at the designated value. Due to this, retaking under the same condition and for the same patient such as retaking after confirmation of hard copy can be conducted easily.

E. Reservation Procedures

There are three inputting methods depending on environment of facilities where the system shown in FIG. 1 is installed.

a. On-line

1) Information necessary for radiographing such as patient information and radiographing information are mostly inputted from RIS in image generating apparatus 1 through the network 10 on an on-line basis.

2) A key board is not needed usually. When information that is not included in information from RIS needs to be inputted, an information inputting apparatus such as a key board is used.

3) Patient information is reserved through a multi-task basis even when radiographing, by inputting orders from a doctor on an on-line basis. Usually, setting is made for each facility so that all pieces of information relating to the patient may be taken in.

4) With regard to radiographing information, orders from a doctor are inputted together with patient information on an on-line basis, and the doctor selects the optimum radiographing method from radiographing key in the case of an order. Or, controller 12 automatically selects the radiographing condition key which is most suitable for the order designated by the doctor.

b. Magnetic Card, Bar Code and Others

1) Only necessary and minimum information such as an ID number or a patient name is inputted on an on-line basis

2) When information that is not included in a card needs to be inputted, it is inputted from the key board.

3) With regard to patient information, necessary and minimum information relating to radiographing is read from a magnetic card. In case of need, collateral information is inputted from a key board.

4) With regard to radiographing information, a radiographing condition key used for preceding radiographing is selected automatically by controller 12. When a change is needed, selection is made from the inside of the radiographing condition key.

c. Key Board Input

1) Necessary information is totally subjected to key board inputting.

2) Patient information is inputted from a key board. Since it is time-consuming to input all of patient ID numbers and patient names manually, it is possible to use a mode to prepare a patient ID number automatically from the number of sheets radiographed (number of sheets which have been radiographed) and radiographing time, to correspond to the order written on a sheet of paper.

3) Radiographing information is selected from a radiographing condition key.

F. Radiographing Procedures

a. The following represents procedures which are followed by a user for radiographing.

1) When the preceding radiographing is completed, or when the sequence enters a radiographing mode, a screen for the following radiographing appears, and radiographing information for radiographing reserved to be at the forefront is displayed on a screen of image display device 13.

2) When there is no reservation, the reservation needs to be made by selecting a radiographing condition key here. A default is a radiographing condition key used in the preceding radiographing. When information for radiographing is insufficient, necessary information needs to be inputted here.

3) A user observes patient information and radiographing information displayed on a screen of the image display device 13 in FIGS. 2 and 4, and confirms whether the setting is correct or not.

4) A user (radiologist) radiographs in the same way as in radiographing by means of a film.

5) Images obtained through radiographing are displayed on a screen of the image display device 13 in succession simultaneously with image reading.

6) Gradation processing is conducted to be displayed again.

7) Success or failure for radiographing and success or failure for processing are displayed on a message basis.

8) A user confirms from images and messages that radiographing has been conducted correctly, and pushes a key for completion of radiographing.

9) When radiographing fails, a user pushes a key for retaking.

b. System Operations in Radiographing

(1) Radiographing mode is started (a radiographing mode key is pressed). When detecting that a radiographing mode key is pressed, the controller 12 makes a control mode to move to a radiographing mode.

(2) When a reservation is made in advance (a reservation file is present), the contents of reservation registered to be at the forefront of a cue for controlling a reservation file are displayed on a screen of the image display device 13.

(3) When there is no reservation, a radiographing condition key used for preceding radiographing is selected automatically by controller 12. If reservation is needed, re-selection and correction of the radiographing condition key and inputting of patient information are conducted.

(4) Radiographing is started by pressing a radiographing switch of a radiation emitting device.

(5) X-rays are irradiated on a subject from the radiation emitting device, and radiographic images accumulated in a stimulable phosphor panel are read by readers 11 and 11a through scanning by excitation light.

(6) Reading control section 36 receives image data from the reader, and stores them in a memory for images while conducting correction processing on a real time basis.

(7) The image data stored in a frame memory are reduced, at image confirming/processing section 35, at the reduction rate designated in advance.

(8) Reduction images obtained through processing in the image confirming/processing section 35 in succession are displayed on a screen of the image display device 13.

(9) After completion of reading and display, digital image information is subjected to image processing in a method designated by a radiographing key in advance, and is displayed again. Reduction images are utilized for image processing.

(10) At the same time, the digital image information is stored in preserving section 31 temporarily.

(11) Images displayed in succession on the image display device 13 and subjected to gradation processing after displaying are displayed again.

(12) After reading is completed, a reservation file and information of conducting radiographing are preserved in preserving section 31 as an image header file.

(13) Reduction image data are preserved in preserving section 31 as a reduction image file.

(14) An image header file and a reduction image data file are controlled together with image data to be corresponded with a common specific number.

(15) Preservation of these files in preserving section 31 is conducted automatically by main control apparatus 34 of the controller 12, after completion of reading by readers 11 and 11a and before confirmation operations of an operator. The reason for this is to prevent that images obtained through radiographing may not be lost even when the power supply is turned off immediately after completion of reading by the accident or by erroneous operations of an operator, even when troubles are caused on the system.

(16) After completion of reading, operations of an operator turn out to be possible.

(17) When an operator judges the radiographing to be normal by observing radiographic images displayed on the image display device 13, a key (key for succeeding radiographing key) for confirming completion of radiographing is inputted from a character information inputting device, and radiographing is completed.

(18) When patient information, an image processing method and an outputting method are required to be changed, it is possible to input new information from the character information inputting device.

(19) When the succeeding radiographing key is pressed, radiographing corresponding to that key is completed, and the following reservation is displayed automatically on the image display device 13.

(20) When the radiographing is judged to have failed, it is possible to cancel the image and to retake by pressing a retaking key.

(21) When the succeeding radiographing key is pressed, radiographing corresponding to that key is completed, and the following processing is conducted.

(22) The reservation file is preserved in preserving section 31 as a radiographed reservation file.

1) When there is a change of information before the succeeding radiographing key is pressed, an image header file preserved at the moment when reading is completed is updated.

2) An image for which radiographing has been finished is registered in a cue for transmission to an outer apparatus.

3) The reservation file reserved next is read and displayed to be capable of being radiographed.

(23) When a retaking key is pressed, radiographing is completed, and the following processing is conducted.

1) Image header file and reduction image file and image data which are preserved at the point of completion of reading are destroyed.

2) Radiographing in the same reservation turns out to be possible.

G. Transmission

(1) Transmission is conducted on a non-synchronization basis.

(2) A cue is made and controlled for each outer apparatus, and each cue operates independently each other, and does not influence each other. Therefore, transmission is conducted for each apparatus on a non-synchronization basis.

(3) Numbers each being given to each image are preserved in a cue in the order of transmission.

(4) The whereabouts of the image in terms of registration in a cue of an outer apparatus is preserved in preserving section 31 as a cue registration table, and it is updated and controlled for each registration and cancellation.

(5) An image registered in the cue is transmitted to an outer apparatus of image server 5 in the order of registration, and the image whose transmission is finished is canceled from the cue.

(6) When carrying out transmission, an image header file and an image data file both stored in preserving section 31 are specified from numbers registered in the cue.

(7) An output image is formed under the condition preserved in the image header file. The image header file is converted into the format determined for each outputting apparatus, and is transmitted together with image data file.

H. Forming Output Image

a. An output image is formed by output image generating section 33 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by radiographing information for each outputting apparatus such as image server 5.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

I. Utility Function

As a utility for a user, some functions are provided thereto.

a. Utility function is restricted by a password for each of general user, a manager and a maker. In particular, for a change of information relating to images, a password of a manager is required for security.

b. Image file operation

1) An image file list is displayed, and information concerning images preserved in preserving section 31 is displayed on image display device 13 in the order of radiographing.

2) When a desired image is selected from the list, patient information, radiographing information and thinned out images are displayed in the same form as in the screen in the case of radiographing.

3) Patient information, image processing methods and outputting methods can be changed.

4) With regard to the image designated to be “reservation” in the case of radiographing, the “reservation” can be canceled by reconfirming here.

5) The image file list can be rewritten in the order of outputting to each outer apparatus.

6) The order of outputting can be changed, including whether outputting to each outer apparatus is conducted or not.

c. Radiographing record, emission record

1) Radiographing information and patient information are processed statistically, and are provided to a user as a radiographing record and an emission record.

2) The number of shots per each radiographing region for a designated period and a list of radiographing conditions for shots per day can be outputted.

Next, the following items A-H relating to medical image processing apparatus 2 shown in FIG. 1 will be explained in detail.

A. Apparatus structure

B. Information

C. File

D. Input and display of main information

E. Image confirming procedures

F. Output

G. Formation of output image

H. Utility function

A. Apparatus Structure

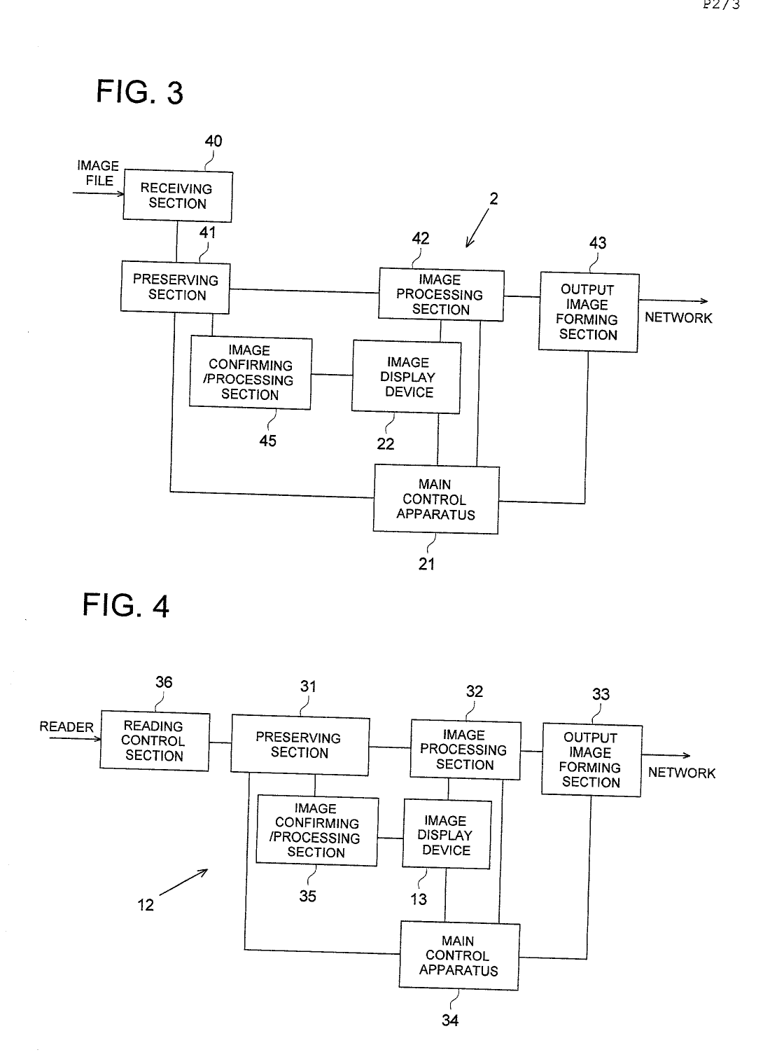

FIG. 3 is a block diagram showing the structure of medical image processing apparatus 2.

a. The medical image processing apparatus 2 shown in FIG. 3 is provided with main control apparatus 21 that controls operations of the whole radiographing system for radiographic images and with image display device 22 for displaying digital image data which are composed of a CRT display and a liquid crystal panel and obtained by medical image generating apparatus 1, and it can be constituted with a personal computer, and includes an information inputting device such as an input key board and a mouse.

As shown in FIG. 3, the image processing apparatus 2 further includes receiving section 40 that receives an image file from image generating apparatus 1 or the like, preserving section 41 that stores information such as an image file that is composed of a hard disc and RAM and received, image processing section 42 that conducts image processing for image information in the image file, output image forming section 43 that forms an output image to be outputted to an outer apparatus, and image confirming/processing section 45 that makes image display device 22 to display reduction images for confirming received images. The sections 40-43 and 44 as well as the image display device 22 are controlled by the main control apparatus 21.

b. Functions of the medical image processing apparatus 2 are as follows, and each function is controlled by the main control apparatus 21.

1) An image file is received by the receiving section 40 from medical image generating apparatus 1.

2) The image file is preserved temporarily in preserving section 41.

3) Image quality is confirmed by reduction images prepared by image confirming/processing section 45.

4) Image processing is carried out on image processing section 42.

5) An output image is formed by output image forming section 43.

6) An output image is transmitted to an outer apparatus such as image server 5 through the network 10.

B. Information

Information handled by the medical image processing apparatus 2 can be classified into the following five types of information.

a. Conditional Information

This is conditional information with which an image file is received and is outputted to an outer apparatus such as image server 5 as a processed image file, and it includes the following.

(a) Image Processing Information

Information relating to gradation processing and frequency processing in image processing section 42.

(b) Output Apparatus Information

This is information about an outer apparatus such as image server 5 that reproduces and outputs image data, and an output area, magnification and reduction rate, output format (multi-format, split radiographing format), overlay and existence of gradation processing and frequency processing are designated for each outputting apparatus such as image server 5.

(c) Overlay Information

This includes information of existence and position of overlay such as AP/PA, R/L and comment.

(d) Specific Designation

Protection information: Even after image output, an image file is preserved until protection is canceled.

Reservation (pending) information: Transmission is reserved. Designation is made when transmission is needed after reviewing an image.

Priority (emergency) information: This is designated when outputting is needed preferentially, such as the case of emergency radiographing.

b. Patient Information

This is information relating to a patient.

(a) Patient ID Information

It includes an ID number, a full name, the distinction of sex and the date of birth all of a patient.

(b) Order Information

This is information with which a doctor requests radiographing.

This includes information about the conditions of a patient and instructions for the date and method relating to the request of inspection.

c. Information of Implementation

This is information relating to the results of receiving and image processing.

(a) The results of receiving and the date and hour of radiographing are included.

(b) Image Processing Result

This is a result of calculation of an image processing parameter, and image data are subjected to image processing based on this result in the case of outputting.

(c) System Information

This includes a part of system information such as a system structure at a point of time when radiographing is conducted.

d. System Information

(a) Information for managing and controlling the system shown in FIG. 1.

(b) Structure the system shown in FIG. 1 (an outer apparatus such as connected image server 5 and its name),

(c) A parameter and a table for controlling apparatuses constituting the system shown in FIG. 1.

(d) Setting information relating to medical image generating apparatus 1 representing an inputting apparatus.

(e) Setting information relating to an outputting apparatus such as information of imager 6 and HOST information

e. Image Data

(a) Image data received from medical image generating apparatus 1.

(b) Reduction image data for display prepared from image data for image confirmation.

(c) Reduction image data for image processing for processing reduction image for display at image confirming/processing section 45.

(d) Output image data subjected to gradation processing and frequency processing.

C. File

A file handled by medical image processing apparatus 2 is preserved in preserving section 41, and it can be classified into the following files in seven types.

a. Condition File

A condition key is a key wherein image processing conditions for image file and output conditions are set in advance, and it has a condition file that corresponds to each condition key. The condition file is composed of the condition information mentioned above. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Main control apparatus 21 establishes a condition file group for each of classified plural classifications, then, sets plural condition files for each condition file group thus established, and preserves in preserving section 41. The optimum condition is selected in the course of generating images.

b Image Header File

After receiving, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

c. Reduction Image file

This represents image data which are obtained by reducing image data at a certain reduction ratio.

(a) Reduction Image Data for Display

This reduction image for display is used by data displayed on image display section 22 in FIG. 3.

(b) Reduction Image Data for Image Processing

This represents reduction image data for calculating a parameter which conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

d. Image File

(a) The image file is composed of image collateral information (image header) and image data.

(b) The image header is composed of condition information, patient information and information of implementation.

When a user refers to condition information, patient information and information of implementation to change, the image header is consulted.

e. Output Image File

This is a file of output image data which have been subjected to designated processing among frequency processing, gradation processing, overlay, rotation and enlargement and reduction.

f. System File

This is one wherein the pieces of information mentioned above are filed.

D. Input and Display of Main Information

a. Received Image Information Display

Received images are displayed on a thumb-nail basis.

b. Output Information Display

1) An output size, a direction, a trimming position, an output position and enlargement reduction methods are designated. These are registered in a condition file in advance.

2) When a condition key is selected, an output area and an output image area are determined by the condition designated in advance, and are displayed on a screen of image display device 22. A size of the output zone display area on the screen of the image display device 22 is assumed to be the maximum output area. The output area and an output image area are displayed graphically on the output zone display area. Due to this, it is possible to select and confirm an appropriate output area and output image area for each apparatus.

c. Overlay Information

1) It is designated whether or not “AP”, “PA”, “R”, “L”, comment and a division are overlaid, or where they are overlaid, and they are registered in a condition file in advance.

2) Output images are displayed on an output zone display area on the screen of the image display device 22, and overlay information is displayed graphically there.

3) It is possible to select an appropriate overlay and to designate its position.

4) It is possible to confirm that a portion screened by the overlay to be invisible is not present. When the overlay causes troubles on diagnoses, it can be moved.

d. Inputting and Outputting of On-line Information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Image List

An image file can be displayed as a list.

E. Image Confirming Procedures

a. Operations of System in Image Confirmation

(1) An image file is received from medical image generating apparatus 1, and is stored in preserving section 41.

(2) The image file stored in a storage medium of the preserving section 41 is reduced at the reduction rate designated by image confirming/processing section 45 in advance.

(3) Reduction images are displayed successively on the screen of image display device 22.

(4) After receiving and completion of display, digital image information is subjected to image processing in the method designated in advance by a radiographing condition key, and is displayed again on image display device 22. Reduction images are used to determine a parameter for image processing.

(5) Images which are displayed successively on the image display device 22 and are subjected to gradation processing after being displayed are displayed again.

(6) When an operator observes received images displayed on the image display device 22 and judges that they are normal images, a key for confirming the completion of receiving is inputted from a character information inputting apparatus, thus, image confirmation is completed.

(7) When patient information, image processing methods and output methods need to be changed, it is possible to input new information from a character information inputting apparatus.

(8) When an image confirming key is pressed, image confirmation for that image is completed, and the following image is displayed automatically.

(9) When an image has a problem, it is possible to change image processing. By reserving it, it is possible to change image processing in detail later.

(10) When an image confirming key is inputted, image confirmation is completed, and the following processing is conducted.

1) The image file is preserved in preserving section 41 as a confirmed image file.

2) Images whose image confirmation has been finished are registered in a cue for outputting to an outer apparatus.

3) Then, the received image file is displayed so that images may be confirmed.

(11) When a reservation key is inputted, image confirmation is completed.

F. Output

1) Output is conducted on a non-synchronization basis with image confirmation.

2) A cue is made and controlled for each outer apparatus, and each cue operates independently each other, and does not influence each other. Therefore, outputting is conducted for each apparatus on a non-synchronization basis.

3) The whereabouts of the image in terms of registration in a cue of an outer apparatus is preserved in preserving section 31 as a cue registration table, and it is updated and controlled for each registration and cancellation.

4) An image registered in the cue is outputted to an outer apparatus in the order of registration, and the image whose outputting is finished is deleted from the cue.

5) When carrying out outputting, an image file stored in preserving section 31 is specified from numbers registered in the cue.

6) An output image is formed under the condition preserved in the image file. The image header is converted into the format determined for each outputting apparatus, and is transmitted together with image data.

G. Forming Output Image

a. An output image is formed by output image forming section 43 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by condition information for each outputting apparatus.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

H. Utility Function

a. As a utility for a user, some functions are provided thereto. Utility function is restricted by a password for each of general user, a manager and a maker. In particular, for a change of information relating to images, a password of a manager is required for security.

b. Image File Operation

1) An image file list is displayed, and information concerning images preserved is displayed on image display device 22 in the order of receiving.

2) When a desired image is selected from the list, patient information, condition information and images are displayed in the same form as in the screen in the case of image confirmation.

3) Patient information, image processing methods and outputting methods can be changed.

4) With regard to the image designated to be “reservation” in the case of radiographing, the “reservation” can be canceled by reconfirming here.

5) The order of outputting can be changed, including whether outputting to each outer apparatus is conducted or not.

c. Radiographing Record, Emission Record

1) Radiographing information and patient information are processed statistically, and are provided to a user as a radiographing record and an emission record.

2) The number of shots per each radiographing region for a designated period and a list of radiographing conditions for shots per day can be outputted.

d. Customizing

A screen and operating procedures can be customized for each user.

Next, reduction images in the present embodiment will be explained as follows.

a. Reduction Image for Image Processing

This is a reduction image for determining a parameter for image processing, and it is prepared by image confirming/processing sections 35 and 45. An image processing parameter is calculated by analyzing the reduction image for image processing. The reduction rate is determined so that a length of one pixel after reduction may be the same as a length designated in advance.

b. Reduction Image for Display

This is a reduction image for displaying images. A plurality of types of reduction images each being suitable for displaying forms and sizes including reduction images for thumb-nail display and large reduction images for image confirmation are preserved.

c. Reduction Image for Web Site

This is a reduction image that is reduced in size and is converted into a JPEG form used commonly on a web site. Due to this, reduction images can be transmitted through the internet.

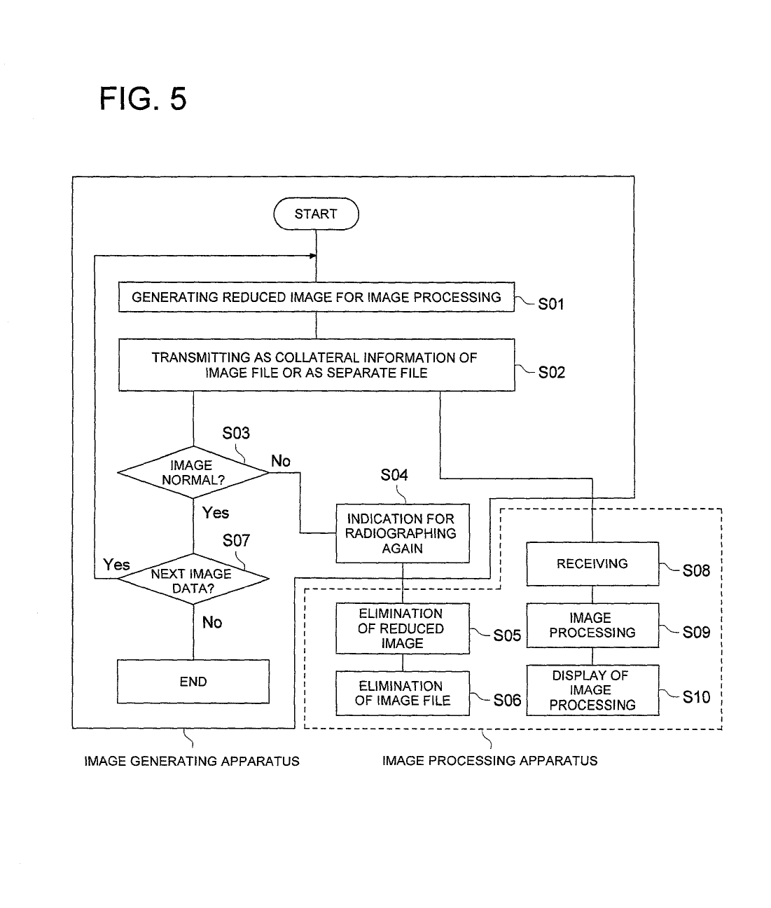

Next, steps S01-S10 covering from preparation of a reduction image up to its display in the medical network system shown in FIG. 1 will be explained, referring to the flow chart in FIG. 5. S01-S04 and S07 represent operations in medical image generating apparatus 1 in FIGS. 1 and 2, and S05, S06 and S08-S10 represent operations in medical image processing apparatus 2. First, how to make a reduction image in the medical image generating apparatus 1 will be explained.

(1) Controller 12 makes a reduction image for image processing with image confirming/processing section 35 shown in FIG. 4 while reading radiographic image information from a stimulable phosphor panel with readers 11 and 11a (S01).

(2) A method of reduction is selected from a simple thinning out method and an averaging method for several pixels.

(3) When a grid is used for radiographing, an averaging method is used because a moiré is caused.

Next, how to transmit reduction images on medical image generating apparatus 1 shown in FIGS. 1 and 2 will be explained.

(1) It is possible to use DICOM Storage, FTP (file transfer protocol), writing in a common disc and original protocol for outputting from the medical image generating apparatus 1 to the network. Incidentally, DICOM is an abbreviation of digital imaging and communications in medicine, and it represents standard specifications about “medical digital image and communication”.

(2) The image generating apparatus 1 transmits reduction images for image processing as a part of collateral information of an image file, utilizing a DICOM private tag (S02). Owing to this, image processing apparatus 2 representing a target for outputting does not need to develop and remake image data on a memory. Therefore, capacity of the memory does not need to be increased, which contributes to cost reduction of the whole system. Further, a period of time required for development of image data becomes unnecessary.

(3) Or, the image generating apparatus 1 may also transmit reduction images for image processing to an apparatus representing a target for outputting as a separate file before transmitting image file (S02). Due to this, the image processing apparatus 2 representing a target for outputting and others do not need to develop and remake image data on a memory, and thereby, capacity of the memory does not need to be increased, which contributes to cost reduction of the whole system. Further, a period of time required for development of image data becomes unnecessary. On the receiving side such as image processing apparatus 2, it is possible to start image processing for reduction images for display before receiving all image files in a large volume, which makes it possible to display reduction images quickly and to confirm received images. Incidentally, it is possible for transmission protocol to use DICOM Storage, FTP, writing in common disc and original protocol.

(4) When reduction images for display and/or reduction images for web site to be used on the web site are transmitted together with reduction images for image processing by the image generating apparatus 1, an image processing apparatus does not need at all to develop and remake image data on a memory.

(5) Transmission of image files including reduction images is started after image reading by readers 11 and 11a and before inputting of a key for “confirming completion of radiographing and for instructing transmission of image file”. Due to this, a period of time required by confirmation of images of radiographing and operations by an operator can be shortened.

(6) An image of radiographing is judged whether it is normal or not (S03), and when it is normal, a key for “confirming completion of radiographing and for instructing transmission of image file” is inputted, and information of “showing that an image was confirmed to be normal” is transmitted to an image processing apparatus representing a target for outputting. When an operator is judged to fail in radiographing, a key for “instructing retaking” is inputted to instruct retaking (S04). Owing to this operation, controller 12 transmits information” images confirmed to be abnormal=instruction to delete image file” to an image processing apparatus representing a target for transmission, and deletes reduction image information transmitted precedently (S05). If an image file has been transmitted, the image file is deleted (S06).

(7) When collateral information of an image file is changed by an operator after transmission of the image file, image generating apparatus 1 transmits only collateral information to the target for transmission again.

(8) Further, in the case of transmitting reduction images as a separate file before transmitting image file, image generating apparatus 1 starts transmission of reduction images, after image reading by readers 11 and 11a and before inputting of a key for “confirming completion of radiographing and for instructing transmission of image file”. Due to this, a period of time required by confirmation of images of radiographing and operations by an operator can be shortened.

(9) In the same way as in the foregoing, an image of radiographing is judged whether it is normal or not, and when a key for “confirming completion of radiographing and for instructing transmission of image file” is inputted, transmission of image file is started. When an operator is judged to fail in radiographing, a key for “instructing retaking” is inputted. Owing to this operation, controller 12 transmits information for “images confirmed to be abnormal=instruction to a target for transmission.

Further, how to receive reduction images by medical image processing apparatus 2 shown in FIGS. 1 and 3 will be explained. Receiving section 40 receives reduction images from image generating apparatus 1 as a part of collateral information or as a separate file (S08). Due to this, main control section 21 of image processing apparatus 2 does not need to develop image data on a memory and to make reduction images. Therefore, capacity of the memory does not need to be increased, which contributes to cost reduction of a medical image processing apparatus and the whole system. Further, a period of time required for development of image data becomes unnecessary.

Next, medical image processing apparatus 2 determines image processing conditions by using reduction images for image processing, then, makes image confirming/processing section 45 to conduct image processing under the determined image processing conditions (S09) and displays reduction images subjected to image processing on image display device 22 (S10). Further, when judged to be normal in step S03 in FIG. 4, the following image data are processed (S07).

The invention has been explained as stated above, referring to the embodiments to which, however, the invention is not limited and can be varied in many ways within a range of technical conception. For example, in addition to the aforesaid CR apparatus wherein radiographic images are read from a stimulable phosphor panel on which radiographic image information of a patient is recorded, the medical image generating apparatus may naturally include a radiogrphing apparatus employing an X-ray flat panel detector, CT (computed tomography: computer tomography device), MRI (magnetic resonance imaging: nuclear magnetic resonance apparatus), DR (digital radiography), and US (ultrasound: ultrasound diagnostic apparatus), or each medical image generating apparatus may also be connected to the medical network system of the invention.

In the medical image generating apparatus, the medical image processing apparatus and the medical network system all of the invention, when reduction images are transmitted as collateral information of image file or as a separate file, image data do not need to be developed on the receiving side. Therefore, the memory therefore is not needed and a period of time required for development of image data becomes unnecessary. Further, when transmitting the reduction images as a separate file, reduction images for display can be displayed on the receiving side and medical images can be confirmed without waiting for completion of receiving of an image file of radiographic images.

What is claimed is:

1. A medical image generating apparatus for generating medical image data and for transmitting said medical image data to another apparatus, comprising:
a means for forming a reduction image for image processing so as to determine image processing conditions from said image data; and
a means for transmitting said reduction image as a part of collateral information of an image file including said image data.

2. A medical image generating apparatus for generating medical image data and for transmitting said medical image data to another apparatus, comprising:
a means for forming a reduction image for image processing so as to determine image processing conditions from said image data; and
a means for transmitting said reduction image as a separate file before transmission of an image file including said image data.

3. A medical image generating apparatus for generating medical image data and for transmitting said medical image data to another apparatus, comprising:
a means for forming a reduction image for a web site from said image data so as to be used in said web site; and
a means for transmitting said reduction image as a part of collateral information of an image file including said image data.

4. A medical image generating apparatus for generating medical image data and for transmitting said medical image data to another apparatus, comprising:
a means for forming a first reduction image for image processing so as to determine image processing conditions from said image data;
a means for forming a second reduction image for display from said image data; and
a means for transmitting said first reduction image and said second reduction image as a part of collateral information of an image file including said image data.

5. A medical image generating apparatus for generating medical image data and for transmitting said medical image data to another apparatus, comprising:
a means for forming a first reduction image for image processing so as to determine image processing conditions from said image data;
a means for forming, from said image data, a second reduction image for a web site to be used in said web site; and
a means for transmitting said first reduction image and said second reduction image as a part of collateral information of an image file including said image data.

6. A medical image generating apparatus for generating medical image data and for transmitting said medical image data to another apparatus, comprising:
a means for forming a reduction image for display from said image data; and
a means for transmitting said reduction image as a separate file before transmitting an image file including said image data.

7. A medical image generating apparatus for generating medical image data and for transmitting said medical image data to another apparatus, comprising:
a means for forming a reduction image for web site to be used in said web site from said image data; and
a means for transmitting said reduction image as a separate file before transmitting an image file including said image data.

8. A medical image generating apparatus for generating medical image data and for transmitting said medical image data to another apparatus, comprising:
a means for forming a first reduction image for image processing for determining image processing conditions from said image data;
a means for forming, from said image data, a second reduction image for display based on said image processing conditions; and
a means to transmitting said first reduction image and said second reduction image as a separate file before transmitting an image file including said image data.

9. A medical image generating apparatus for generating medical image data and for transmitting said medical image data to another apparatus, comprising:
a means for forming a first reduction image for image processing for determining image processing conditions from said image data;
a means for forming, from said image data, a second reduction image for web site to be used in said web site based on said image processing conditions; and
a means for transmitting said first reduction image and said second reduction image as a separate file before transmitting an image file including said image data.

10. The medical image generating apparatus of claims 1, comprising a means for transmitting said image file before an operator of said image file instructs said transmission.

11. The medical image generating apparatus of claim 10, comprising a means for instructing deletion of said image file, transmitted from said transmitting means, to a target apparatus for transmission when discontinuation of transmission of said image file is instructed.

12. The medical image generating apparatus of claim 10, comprising a means for transmitting only a changed portion of said collateral information when said collateral information of said image file is changed after transmission of said image file.

13. The medical image generating apparatus of claim 2, comprising a means for transmitting said reduction image before transmission of said image file.

14. The medical image generating apparatus of claim 13, comprising a means for instructing deletion of said reduction image, transmitted to a target apparatus, when discontinuation of transmission of said image file is instructed.

15. A medical image processing apparatus, comprising:
a means for receiving said image file and said reduction image, transmitted from said medical image generating apparatus of claim 15;
a means for determining image processing conditions by using said reduction image; and
a means for displaying said reduction image which has been subjected to image processing based on said image processing conditions.

16. A medical image processing apparatus, comprising:
a means to receiving said image file and said second reduction image, transmitted from said medical image generating apparatus of claim 4; and
a means for displaying said second reduction image which has been subjected to image processing based on said image processing conditions.

17. A medical network system, comprising:
said medical image generating apparatus of claim 1; and
a medical image processing apparatus, comprising:
a) a means for receiving said image file and said reduction image, transmitted from said medical image generating apparatus through a network;
b) a means for determining image processing conditions by using said reduction image; and
c) a means for displaying said reduction image which has been subjected to image processing based on said image processing conditions.

18. A medical network system, comprising:
said medical image generating apparatus of claim 4; and
a medical image processing apparatus, comprising:
a) a means for receiving said image file and said second reduction image for display, transmitted from said medical image generating apparatus through a network; and
b) a means for displaying said second reduction image which has been subjected to image processing based on said determined image processing conditions.

19. The medical network system of claim 17, wherein said medical image generating apparatus includes a means for transmitting said image file to said medical image processing apparatus before an operator instructs a transmission of said image file.

20. The medical network system of claim 19, wherein said medical image generating apparatus includes a means for instructing deletion of said transmitted image file to said medical image processing apparatus when discontinuation of transmission of said image file is instructed.

21. The medical network system of claim 19, wherein said medical image generating apparatus includes a means for transmitting only changed portion of said collateral information when said collateral information of said image file is changed after transmission of said image file.

22. The medical network system of claim 17, wherein said medical image generating apparatus includes a means for transmitting said reduction image to said medical image processing apparatus before transmission of said image file.

23. The medical network system of claim 22, wherein said medical image generating apparatus includes a means for instructing deletion of said reduction image to said medical image processing apparatus when discontinuation of transmission of said image file is instructed.
